(19) United States
(12) Patent Application Publication
(10) Pub. No.: US 2009/0093160 A1
(43) Pub. Date: Apr. 9, 2009

(54) FILTER AND HOUSING THEREOF

(75) Inventors: Shin-Chih HSIEH, Taoyuan Hsien (TW); Po-Jen Tsai, Taoyuan Hsien (TW)

Correspondence Address: Muncy, Geissler, Olds & Lowe, PLLC, P.O. BOX 1364, FAIRFAX, VA, 22038-1364, US

(73) Assignee: DELTA ELECTRONICS, INC.

(21) Appl. No.: 12/141,560

(22) Filed: Jun. 18, 2008

(30) Foreign Application Priority Data
Oct. 5, 2007 (TW) 96137370

(51) Int. Cl. H01R 13/66

(52) U.S. Cl. 439/620.1

(57) ABSTRACT

A filter includes a housing and a filter device. The housing includes a base and an outer case. The base includes a main body, an accommodating part, a power-inputting terminal, a first grounding terminal and a second grounding terminal. The second grounding terminal has a flexible portion disposed on the periphery of the main body and a connecting portion connected to the first grounding terminal. The filter device disposed in the accommodating part of the base of the housing includes at least one filtering device. The outer case partially covers the periphery of the main body and the accommodating part and contacts the flexible portion of the second grounding terminal.

### BACKGROUND OF THE INVENTION

This Non-provisional application claims priority under 35 U.S.C. §119(a) on Patent Application No(s). 096137370 filed in Taiwan, Republic of China on Oct. 5, 2007, the entire contents of which are hereby incorporated by reference.

### FIELD OF THE INVENTION

The invention relates to a filter and a housing thereof and, more particularly, to a filter and a housing thereof providing a new grounding design to save material usage and increase space utility.

### DESCRIPTION OF THE RELATED ART

With the more delicate of electronic devices, packing for electronic components and protecting structures thereof is more demanded.

As shown in FIGS. 1-5, the shell-type filter includes a power socket 11, a plastic housing 12, an U-shaped metallic sheet 13 and a metallic outer case 14. The power socket 11 includes a grounding terminal 111. The plastic housing 12 includes a bottom 121, a recess 122 formed on the bottom 121, and a Y-capacitors 123 with hooks “H”. One end of the metallic sheet 13 is welded to the grounding terminal 111 of the power socket 11, and the other end is directly formed as a flat-plate terminal 131 provided with a connecting portion 132. The metallic outer case 14 includes an opening 141. The plastic housing 12 is used for receiving Y-capacitors 123 and inductors (not shown). When the power socket 11, the plastic housing 12 and the metallic sheet 13 are assembled, the plastic housing 12 is correspondingly connected to the power socket 11, the metallic sheet 13 received in the recess 122 is crossed along the bottom 121 of the plastic housing 12, and the flat-plate terminal 131 of the metallic sheet 13 is outwardly extended with respect to the plastic housing 12.

As shown in FIG. 3, when the Y-capacitors 123 are disposed in the plastic housing 12, the hooks “H” of the Y-capacitors 123 are hooked at the connecting portion 132 of the flat-plate terminal 131, and thus, electrical connection is achieved therebetween. In FIG. 4, the power socket 11 and the plastic housing 12 received with Y-capacitors 123 and inductors are socketed into the metallic outer case 14, thereby penetrating the flat-plate terminal 131 through the opening 141 of the metallic outer case 14. In FIG. 5, when the penetrated flat-plate terminal 131 is soldered to the metallic outer case 14, the assembled shell-type filter 1 provided with grounding function is formed.

To obtain the assembled shell-type filter 1 with a flat packing appearance, the recess 122 formed on the outside of the bottom 121 must be suitably provided for receiving the crossed metallic sheet 13. However, the inwardly formed recess 122 on the bottom 121 affects the utility of the inner space of the plastic housing 12. Furthermore, given increased raw material prices, it would be advantageous if the soldering process were to be eliminated, while remaining a grounding function, i.e., reducing the use of metallic material and welding tin.

### BRIEF SUMMARY OF THE INVENTION

The invention provides a filter and a housing thereof to simplify the assembly process of the filter so that the manufacturing cost can be reduced and the quality of the filter products can be increased.

To achieve the purposes above, a housing for a filter of the invention includes a base and an outer case. The base includes a main body, an accommodating part, a first grounding terminal and a second grounding terminal. The main body has a periphery. The accommodating part is connected to the main body. The second grounding terminal comprises a flexible portion disposed on the periphery of the main body and a connecting portion connected to the first grounding terminal. The outer case partially covers the periphery of the main body and the accommodating part and contacts the flexible portion of the second grounding terminal.

Further, the invention provides a filter comprising a housing and a filter device. The housing comprises a base and an outer case. The base comprises a main body, an accommodating part, a first grounding terminal and a second grounding terminal. The main body has a periphery. The accommodating part is connected to the main body. The second grounding terminal has a flexible portion disposed on the periphery of the main body and a Connecting portion connected to the first grounding terminal. The outer case partially covers the periphery of the main body and the accommodating part and contacts the flexible portion of the second grounding terminal. The filter device disposed in the accommodating part of the base of the housing has at least one filtering device.

Based on the described design applied on the filter of the invention, compared to the conventional metal sheet, the volume of the metallic second grounding terminal can be reduced due to the second grounding terminal directly contacting with the metallic case via the flexible portion. Further, due to the outer case with the third grounding terminal being integrally formed as a monolithic piece by punching, utilization rate of the material can be increased and the amount of metallic materials in use can be reduced, and therefore the outer case can provide available space to suitably receive the filter device therein.

A detailed description is given in the following embodiments with reference to the accompanying drawings.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of component parts of a conventional shell-type filter;

FIG. 2 is a perspective view of the assembled components of the shell-type filter of FIG. 1;

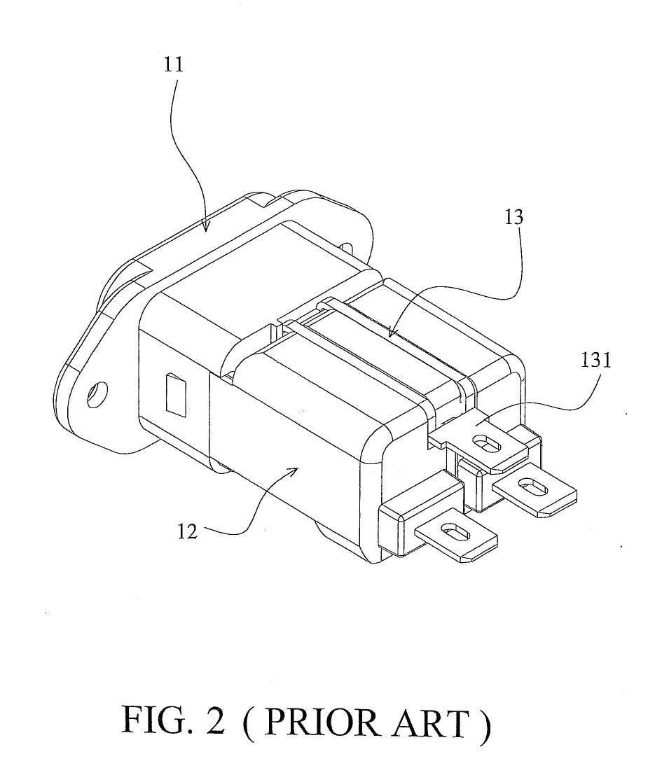

FIG. 3 is another exploded view of the assembled components of the shell-type filter of FIG. 2;

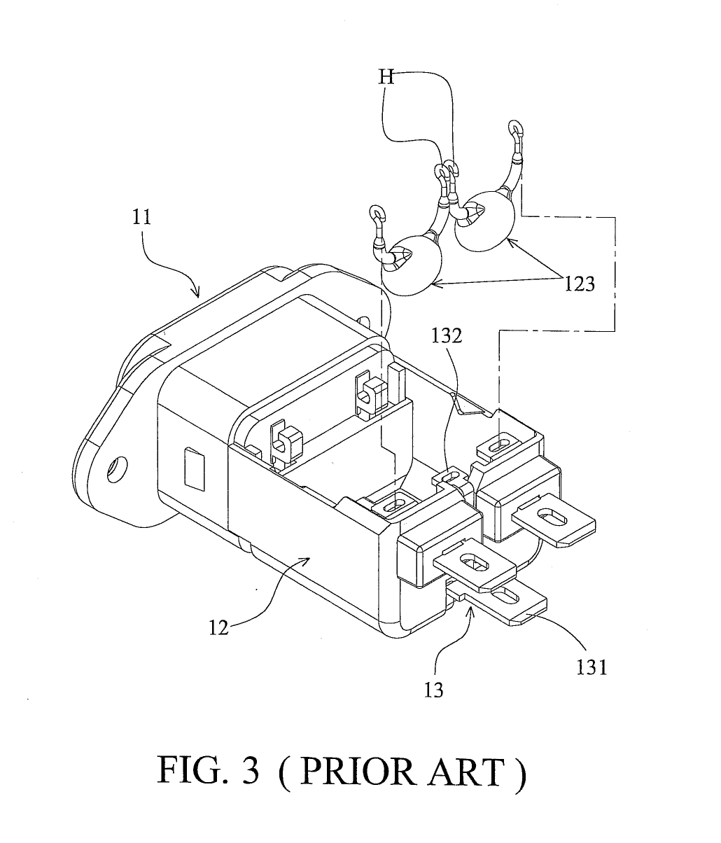

FIG. 4 is an exploded view of the assembled conventional shell-type filter;

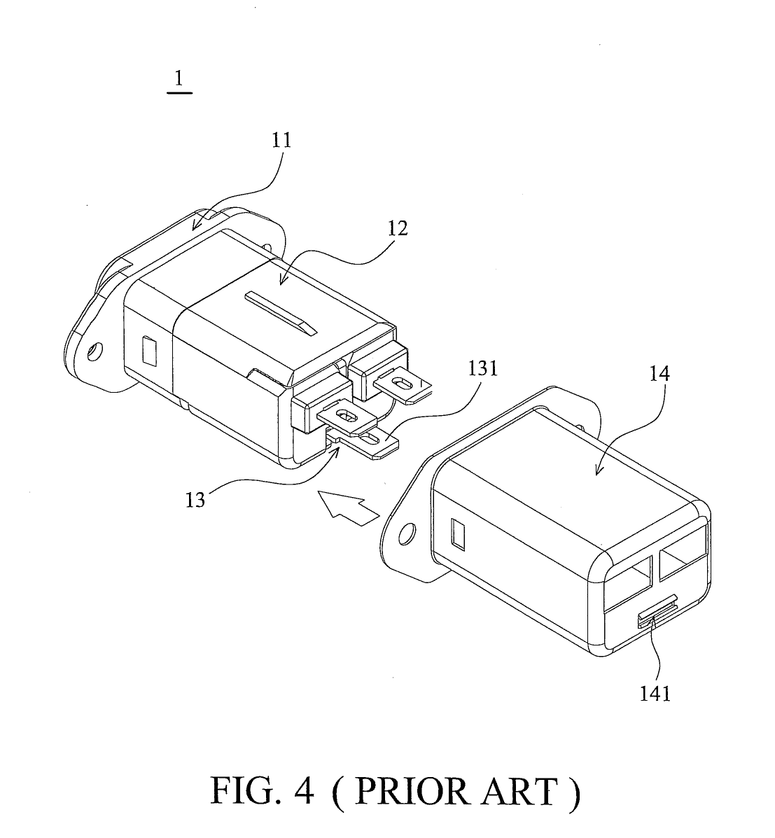

FIG. 5 is a schematic view of the assembled shell-type filter of FIG. 4;

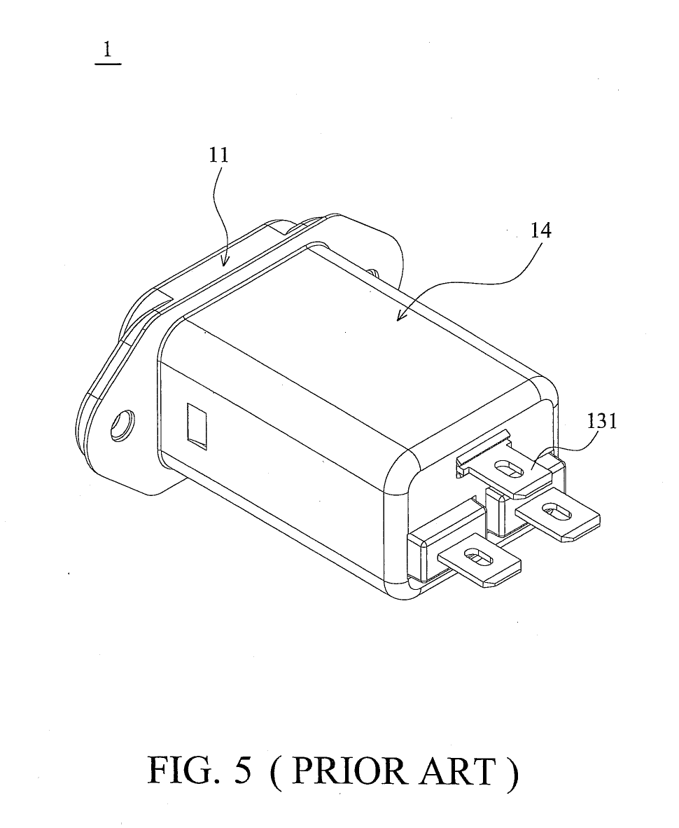

FIG. 6 is an exploded view of a filter and a housing thereof of an embodiment of the invention;

FIG. 7 is a schematic view of a base of FIG. 6;

FIG. 8 is an exploded view of the filter and the housing thereof of FIG. 6;

FIG. 9 is a schematic view of an inversed assembly of the filter and the housing thereof with respect to the view position of FIG. 8;

FIG. 10 is a side view of the assembly of the filter and the housing thereof of FIG. 9;

FIG. 11 is a partially enlarged view of a region (“P”) of FIG. 10;

FIG. 12 is a bottom view of the assembly of the filter and the housing thereof of FIG. 9; and

FIG. 13 is a partially enlarged view of a region (“Q”) of FIG. 12.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

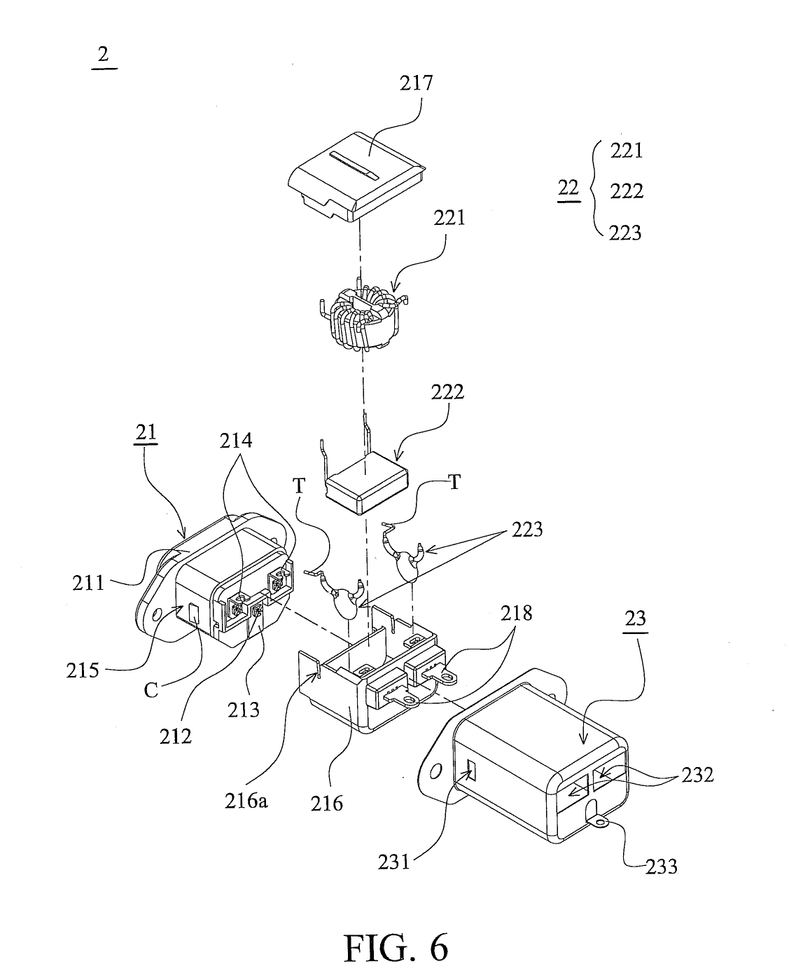

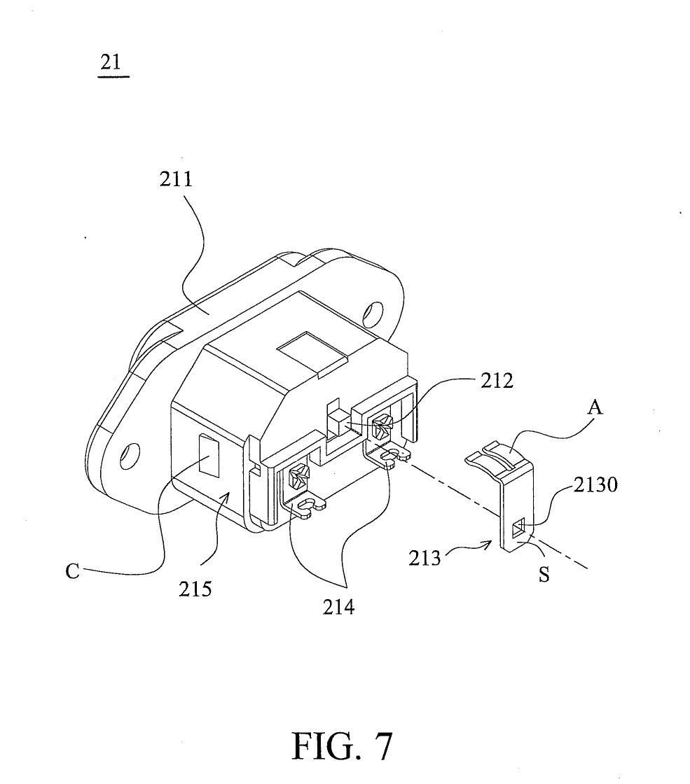

In FIGS. 6, 7, and 8, a filter 2 of an embodiment according to an embodiment of the present invention includes a base 21, a filter device 22, and an outer case 23. The outer case 23 is formed with a first opening 231, a plurality of second openings 232 and a third grounding terminal 233. The base 21 includes a main body 211, a power-inputting terminal 214, a first grounding terminal 212, a second grounding terminal 213, an accommodating part 216 and a cover 217. The main body 211 has a periphery 215 formed with a clipping portion “C”. The power-inputting terminal 214 is connected to the filter device 22. The second grounding terminal 213 is formed with an L-shaped profile. The accommodating part 216 is connected to the main body 211. The first opening 231 of the outer case 23 is corresponding to the clipping portion “C” formed at the periphery 215 of the main body 211 of the base 21, and the second openings 232 of the outer case 23 are corresponding to the power-inputting terminal 214 so that the power-inputting terminal 214 can protrude therethrough. The main body 211 is made by an insulating material such as plastic. The second grounding terminal 213 includes a flexible portion “A” disposed on the periphery 215 of the main body 211 and a connecting portion “S” (shown in FIG. 7) connected to the first grounding terminal 212. When the outer case 23 is jacketed to the base 21, the flexible portion “A” of the second grounding terminal 213 is contacted with the outer case 23. The accommodating part 216 and the cover 217 are made by an insulating plastic. The filter device 22 includes an X-capacitor 221, an inductor 222, and a Y-capacitor 223 having a leg “T”. The filter device 22 is disposed in the accommodating part 216 of the base 21. The cover 217 covers the accommodating part 216 when the filter device 22 is disposed in the accommodating part 216. The outer case 23 partially covers the periphery 215 of the main body 211 and the accommodating part 216, and thus, the flexible portion “A” of the second grounding terminal 213 can be contacted against the outer case 23. When the base 21 and the outer case 23 are assembled, the outer case 23 is contacted against the flexible portion “A” of the second grounding terminal 213 and the leg “T” of the Y-capacitor 223.

In FIG. 7, the first grounding terminal 212 is connected to the connecting portion “S” of the second grounding terminal 213 by riveting, screwing, welding locking or engaging. In the embodiment, a hole 2130 is formed at the connecting portion “S” of the second grounding terminal 213. By penetrating the first grounding terminal 212 through the hole 2130 located at the connecting portion “S” of the second grounding terminal 213 and impacting on the distal end of the first grounding terminal 212 by a tool (not shown), the first grounding terminal 212 serves as a limiting brim to engage to the second grounding terminal 213.

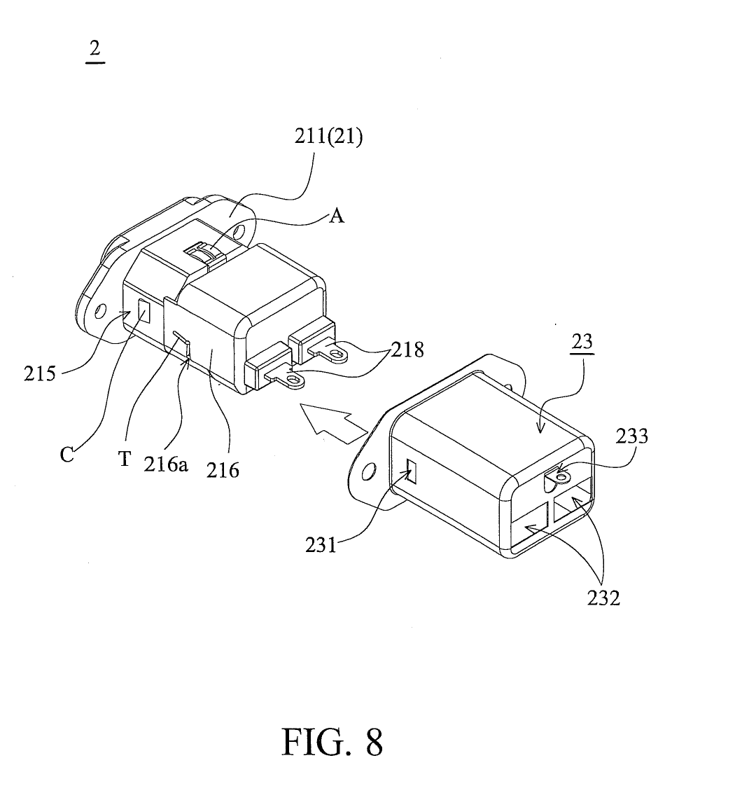

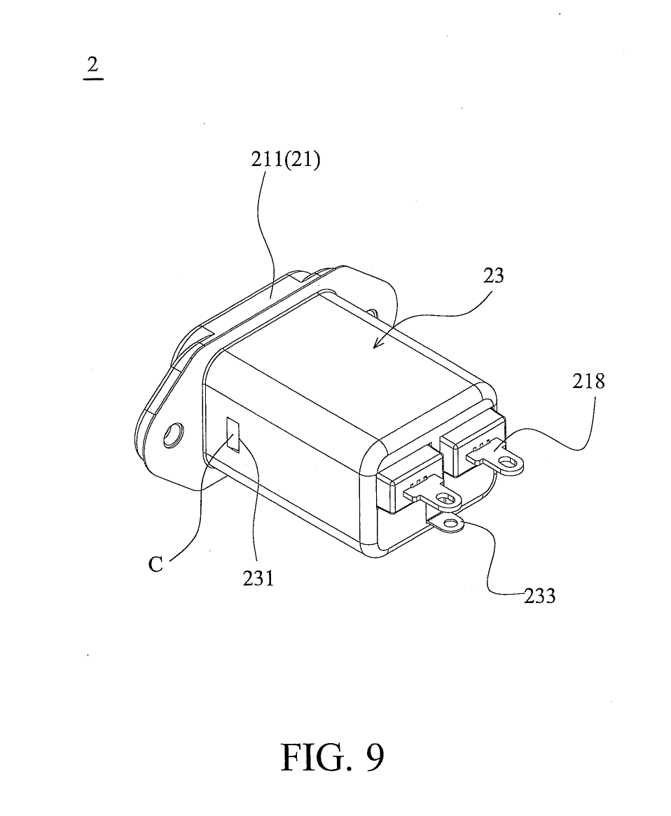

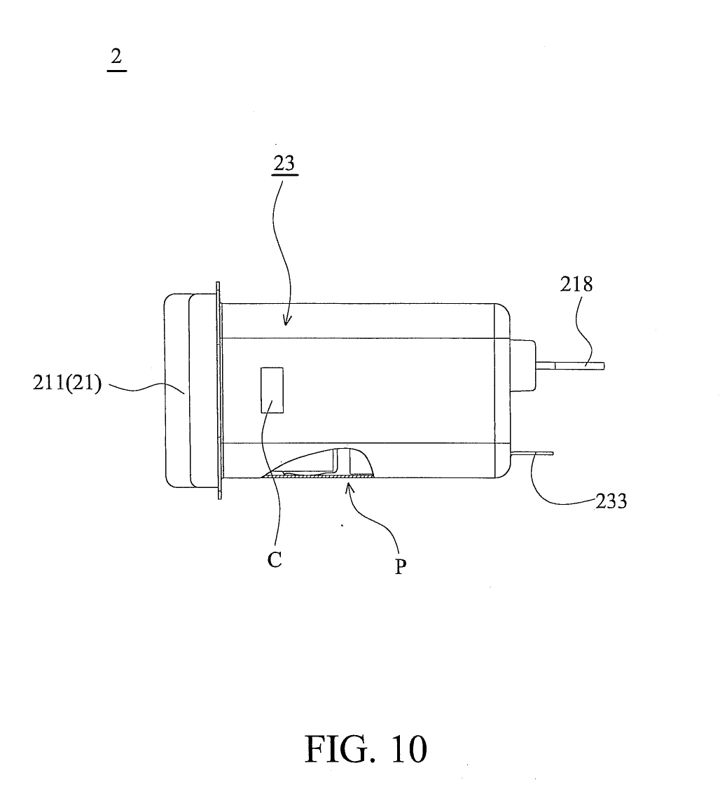

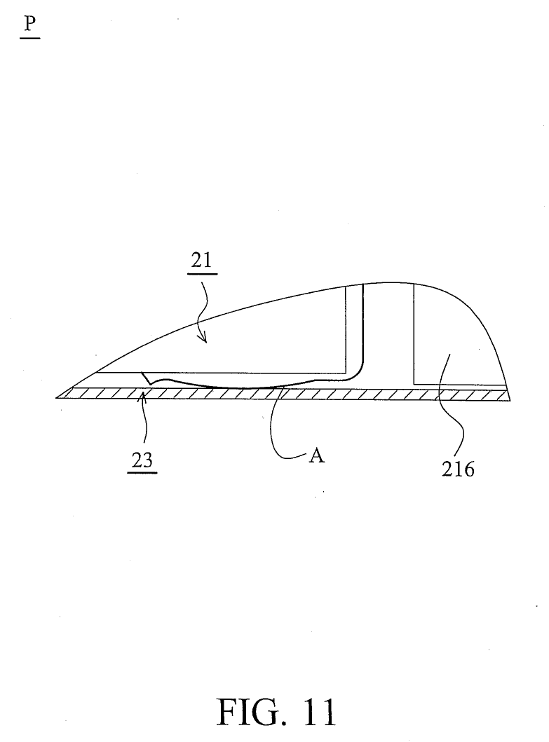

Referring to FIGS. 8, 9, 10 and 11 simultaneously, FIG. 9 is an inversed schematic view of the assembly of the filter and the housing thereof with respect to the view position of FIG. 8, FIG. 10 is a side view of the assembly of the filter and the housing thereof of FIG. 9, and FIG. 11 is a partially enlarged view of a region “P” of FIG. 10. When the outer case 23 is jacketed to the base 21 assembled with the filter device 22, the flexible portion “A” of the L-shaped second grounding terminal 213 is pressed against the periphery 215 of the main body 211. A projected arc profile or an arch, corresponding to the periphery 215 of the main body 211, can be formed at a longitudinal or transverse section of the flexible portion “A” of the second grounding terminal 213. In FIG. 11, the longitudinal section of the flexible portion “A” of the second grounding terminal 213 of the embodiment has an arc profile, thereby providing a flexible allowance to assure the contact of the outer case 23 and the flexible portion “A” of the second grounding terminal 213. The first grounding terminal 212, the second grounding terminal 213 and the power-inputting terminal 214 are made by a metallic material or an alloy thereof. The outer case 23 is made of a metallic material or an alloy thereof.

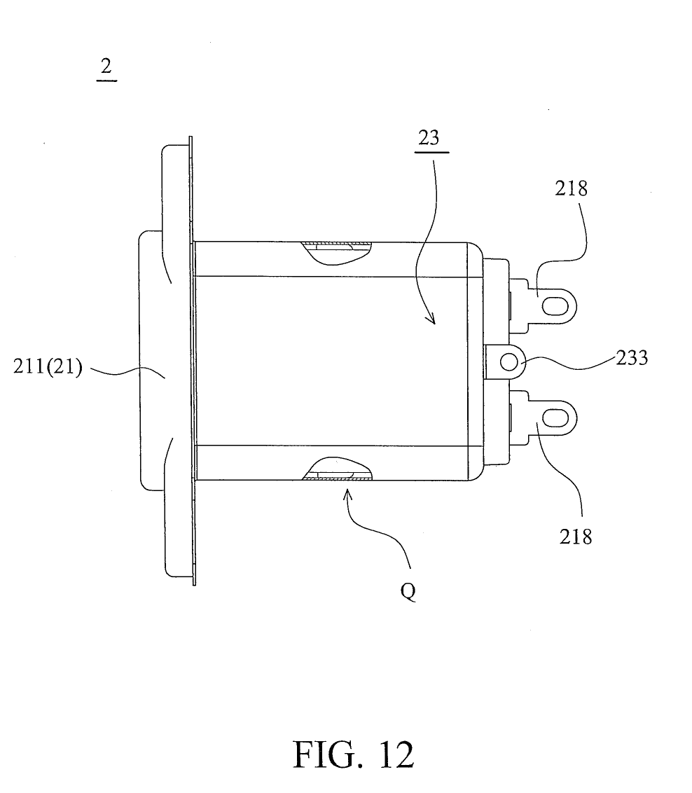

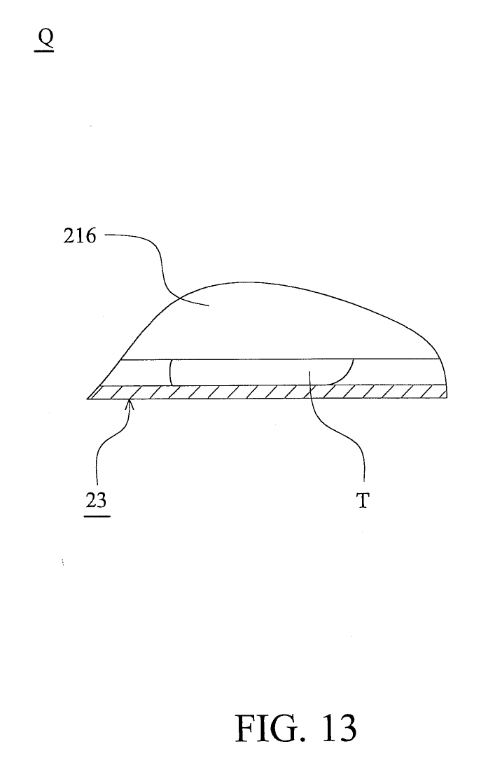

Referring to FIGS. 6, 8, 9, 12 and 13 simultaneously, FIG. 12 is a bottom view of the assembly of the filter and the housing thereof of FIG. 9, and FIG. 13 is a partially enlarged view of a region “Q” of FIG. 12. Due to the accommodating part 216 and the cover 217 made by the insulating plastic, short circuiting occurring on the filter 2 and the housing thereof is prevented. The accommodating part 216 includes a third opening 216a located on both sides thereof, thereby providing for cross installation of the leg “T” of the Y-capacitor 223. A power-outputting terminal 218, made by a metallic material or an alloy thereof, is formed at one end of the accommodating part 216 and electrically connected to the filter device 22. When the filter device 22 is disposed in the accommodating part 216 of the base 21, the leg “T” of the Y-capacitor 223 is crossed over the third opening 216a of the accommodating part 216. That is, the leg “T” of the Y-capacitor 223 situated in cross installation is contacted with the outer case 23.

In FIG. 9, during the assembly of the described components, the base 21, the filter device 22 and the outer case 23 are assembled by engaging the clipping portion “C” formed at the periphery 215 of the base 21 with the first opening 231 of the outer case 23, and the power-outputting terminal 218 formed at the accommodating part 216 is penetrated through the corresponded second openings 232 of the outer case 23. In the embodiment, the outer case 23 having the third grounding terminal 233 is integrally formed as a monolithic piece by punching, and the third grounding terminal 233 is applicable for connecting to an external system (not shown).

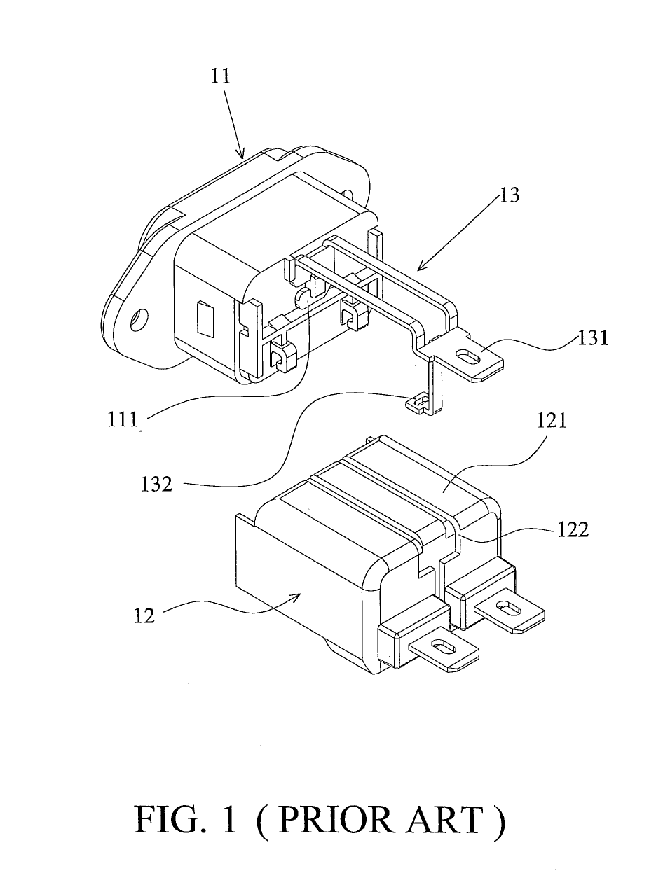

Based on the described design applied on the filter 2 of the embodiment, the volume of the metallic second grounding terminal 213 is reduced compared to the conventional metal sheet 13 in FIG. 1, and the second grounding terminal 213 and the Y-capacitor 223 are directly contacting with the metallic outer case 23 via the flexible portion “A” and the accommodating part 216, thus, grounding is achieved therebetween. Further, due to the outer case 23 with the third grounding terminal 233 being integrally formed as a monolithic piece by punching, utilization rate of the material can be increased and the amount of metallic materials in use can be reduced, and therefore the outer case 23 provides available space to suitably receive the filter device 22 therein.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A filter comprising:
a housing comprising:
a base comprising a main body; a accommodating part connected to the main body; a first grounding terminal; and a second grounding terminal having a flexible portion disposed on the main body and a connecting portion connected to the first grounding terminal; and
an outer case for covering the housing and contacting the flexible portion of the second grounding terminal.

2. The filter as claimed in claim 1, wherein the first grounding terminal is connected to the connecting portion of the second grounding terminal by riveting, screwing, welding, locking or engaging.

3. The filter as claimed in claim 1, wherein the housing further comprises a projected arc profile along at a longitudinal or transverse section of the flexible portion of the second grounding terminal.

4. The filter as claimed in claim 1, wherein the second grounding terminal has an L-shaped profile.

5. The filter as claimed in claim 1, further comprising a filter device disposed in the accommodating part of the base of the housing.

6. The filter as claimed in claim 1, wherein the base further comprises a power-inputting terminal connected to the filter device.

7. The filter as claimed in claim 6, wherein the outer case comprises a second opening corresponding to the power-inputting terminal.

8. The filter as claimed in claim 6, wherein the first grounding terminal, the second grounding terminal and the power-inputting terminal are made of a metallic material or an alloy thereof.

9. The filter as claimed in claim 1, wherein the main body comprises a clipping portion and the outer case comprises a first opening corresponding to the clipping portion.

10. The filter as claimed in claim 1, wherein the main body comprises an insulating material or plastic.

11. The filter as claimed in claim 1, wherein the filter device comprises a capacitor or an inductor.

12. The filter as claimed in claim 11, wherein the capacitor comprises an X-capacitor or Y-capacitor.

13. The filter as claimed in claim 12, wherein the Y-capacitor comprises a leg.

14. The filter as claimed in claim 13, wherein the accommodating part comprises a third opening provided for cross installation of the leg of the Y-capacitor.

15. The filter as claimed in claim 14, wherein the leg of the Y-capacitor situated in cross installation is contacted with the outer case.

16. The filter as claimed in claim 1, wherein the outer case comprises a third grounding terminal.

17. The filter as claimed in claim 16, wherein the outer case and the third grounding terminal are integrally formed as a monolithic piece.

18. The filter as claimed in claim 1, wherein the outer case is made of a metallic material or an alloy thereof.

19. The filter as claimed in claim 1, further comprising a cover for covering the accommodating part.
